(19) United States
(12) Patent Application Publication
(10) Pub. No.: US 2011/0164275 A1
(43) Pub. Date: Jul. 7, 2011

(54) PRINTING APPARATUS, CONTROL METHOD FOR PRINT JOB IN THE PRINTING APPARATUS, AND STORAGE MEDIUM HOLDING PROGRAM

(75) Inventor: Susumu Mikura, Nagareyama-shi (JP)

(73) Assignee: CANON KABUSHIKI KAISHA, Tokyo (JP)

(21) Appl. No.: 12/960,374

(22) Filed: Dec. 3, 2010

(30) Foreign Application Priority Data
Jan. 7, 2010 (JP) 2010-002373

(51) Int. Cl. G06F 3/12

(52) U.S. Cl. 358/1.15

(57) ABSTRACT

A printing apparatus receives, from an information processing apparatus, a request for a list of print jobs, from among print jobs that are on hold, that have entered a printable state, detects, from among the print jobs that are on hold, print jobs that were sent from the information processing apparatus and that have entered the printable state, and sends the list of detected print jobs to the information processing apparatus. The information processing apparatus requests a list of print jobs, from among the print jobs that are on hold, that have entered the printable state, acquires the list sent from the printing apparatus, and determines whether to print selected print jobs indicated in the acquired list or all of the print jobs indicated in the acquired list.

### BACKGROUND OF THE INVENTION

1. Field of the Invention

The present invention relates to printing apparatuses that process print jobs, control methods for print jobs in such printing apparatuses, and storage media holding programs.

2. Description of the Related Art

Generally speaking, a printing system is configured of multiple host computers connected to a printing apparatus over a network. When a user uses his or her host computer to specify an output destination printing apparatus and instructs printing to be carried out, a print job that can be interpreted by the printing apparatus is generated by that host computer. The generated print job is then sent to the specified output destination printing apparatus. Upon receiving the image data, the printing apparatus interprets the data and converts that data into intermediate code, generates print image data, and carries out an image formation process.

When executing printing, the user sets various parameters related to printing. The print quality, paper supply method, type of paper to be used, and so on are examples of such parameters. When the user sets these parameters and instructs printing to be carried out from the host computer, a print job including information of the various parameters is generated and sent to the specified output destination printing apparatus. The printing apparatus receives the print job and analyzes the portion containing the parameters, and determines the print quality to be used during printing, the paper supply unit to be used for paper supply, the type of paper to be used for printing, and so on.

Here, for example, in the case where there is no paper in the specified paper supply unit, a message such as “There is no paper. Please set paper” is displayed in a display unit of an operation panel in the printing apparatus, prompting the user to set some paper. Likewise, in the case where a different type of paper from the paper that is specified by the print job is set, a message such as “The wrong type of paper is set. Please change the paper” is displayed, prompting the user to change the paper to the type of paper specified in the print job.

However, the printing apparatus is standing by for user operations while the aforementioned states are occurring, and thus the printing apparatus remains in a standby state until the user goes to the printing apparatus and takes some sort of action. Meanwhile, the printing apparatus is connected to the network and receives print jobs from multiple users, and thus there has been a problem in that subsequent print jobs cannot be executed while the printing apparatus is in this standby state.

A print job hold function is used in order to prevent this problem from occurring (see Japanese Patent Laid-Open No. 2004-288032). In the case where it has been determined that a print job received by the printing apparatus cannot be executed for some reason, the print job hold function loads the print job into a temporary holding region such as a hard disk and puts the print job on hold rather than entering an error state prompting paper to be set, paper to be changed, or the like. As a result, the printing apparatus does not enter an error state, and subsequent jobs can be received and executed. The hold state is canceled and the print job that was on hold is executed when the paper specified in the print job has been set.

Because a printing system is normally configured of multiple host computers connected to the printing apparatus over a network, it is often the case that on-hold jobs from multiple users are present in the printing apparatus. When paper is changed or set in order to release an on-hold job instructed to be printed by a user, there are cases where the printing of multiple on-hold jobs that can be printed due to the on-hold job being released starts. However, there are also cases where those multiple on-hold jobs are not from the same user. Therefore, the actions taken by one user to release his/her on-hold job results in the on-hold jobs of other users being printed indiscriminately.

Furthermore, in the case where, for example, another user cannot go to the printing apparatus to pick up his/her printed material at that time, that printed material is left as-is. Furthermore, in the case where another user has put a print job on hold in the printing apparatus and then sent that print job to another printing apparatus and printed the print job, two copies of the same printed material will be generated, resulting in waste, if paper is set, paper is changed, or the like in the first printing apparatus and the on-hold print job is printed by that first apparatus.

In order to solve this problem, it is conceivable for the user to select and print one on-hold job at a time using an operation unit in the printing apparatus, the host computer, or the like, instead of automatically releasing and printing on-hold jobs when paper is set, paper is changed, and so on. However, in that case, it is necessary for the user who has changed the paper to select one on-hold job at a time when he/she wishes to release and print multiple on-hold jobs all at once, which leads to an extremely complicated operational process.

### SUMMARY OF THE INVENTION

An aspect of the present invention is to eliminate the above-mentioned problems with the conventional technology. The present invention provides a printing apparatus that selects the optimum process for a print job whose printing process has been put on hold, a control method for a print job, and a storage medium that holds a program.

The present invention in its first aspect provides a printing apparatus comprising a detection unit configured to detect, among print jobs that are on hold, a print job that has entered a printable state; an output unit configured to output a list of print jobs detected by the detection unit; and a processing unit configured to carry out a printing process on a print job specified from among the print jobs included in the list output by the output unit.

The present invention in its second aspect provides a print job control method comprising the steps of detecting, among print jobs that are on hold in a printing apparatus, a print job that has entered a printable state; outputting a list of the detected print jobs; and carrying out, in the printing apparatus, a printing process on a print job specified from among the print jobs included in the output list.

The present invention in its third aspect provides a computer-readable storage medium in which is stored a program that can be executed by a computer, the program causing the computer to detect, among print jobs that are on hold in a printing apparatus, a print job that has entered a printable state; output a list of the detected print jobs; and carry out, in the printing apparatus, a printing process on a print job specified from among the print jobs included in the output list.

According to the present invention, it is possible to select the optimum process for a print job whose printing process has been put on hold.

Further features of the present invention will become apparent from the following description of exemplary embodiments with reference to the attached drawings.

### BRIEF DESCRIPTION OF THE DRAWINGS

FIG. 1 is a diagram illustrating the overall configuration of a printing system according to an embodiment of the present invention.

FIG. 2 is a block diagram illustrating a printing apparatus in the aforementioned printing system.

FIG. 3 is a block diagram illustrating a host computer in the aforementioned printing system.

FIG. 4 is a diagram illustrating the steps of a process for putting a print job on hold.

FIG. 5 is a diagram illustrating the steps of a process for releasing an on-hold job in a printing apparatus.

FIGS. 6A and 6B are diagrams illustrating examples of messages displayed in a printing apparatus.

FIG. 7 is a diagram illustrating the steps of a process by which a printing apparatus sends on-hold job list information.

FIG. 8 is a diagram illustrating the steps of a process by which a host computer receives on-hold job list information.

FIGS. 9A and 9B are diagrams illustrating examples of confirmation messages displayed in an information processing apparatus.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Note that identical constituent elements will be given identical reference numerals, and descriptions thereof will be omitted.

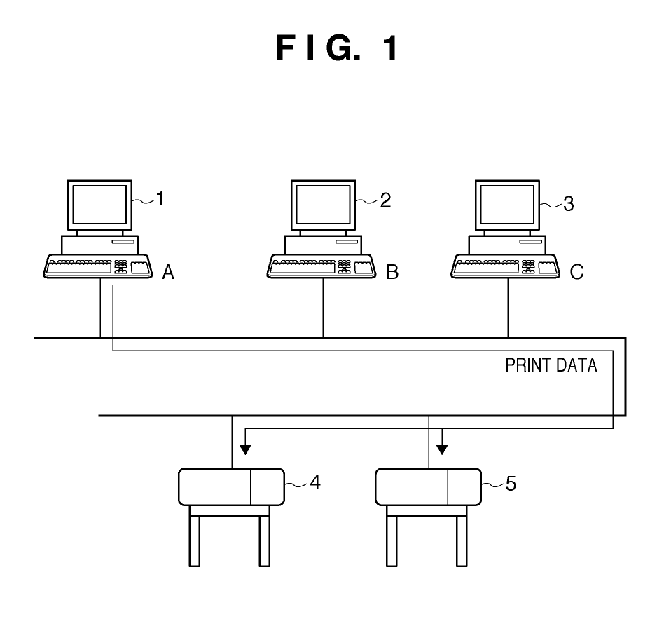

FIG. 1 is a diagram illustrating the overall configuration of a printing system according to an embodiment of the present invention. In this printing system, three host computers 1, 2, and 3 and two printing apparatuses 4 and 5 are connected via a network. The host computer 1 is used by a user A, the host computer 2 is used by a user B, and the host computer 3 is used by a user C. Each user specifies one of the two printing apparatuses and executes printing of image data, document data, or the like. For example, in the case where the printing apparatus 4 is executing printing for the user B when the user A attempts to print, the user A can execute printing by specifying the printing apparatus 5.

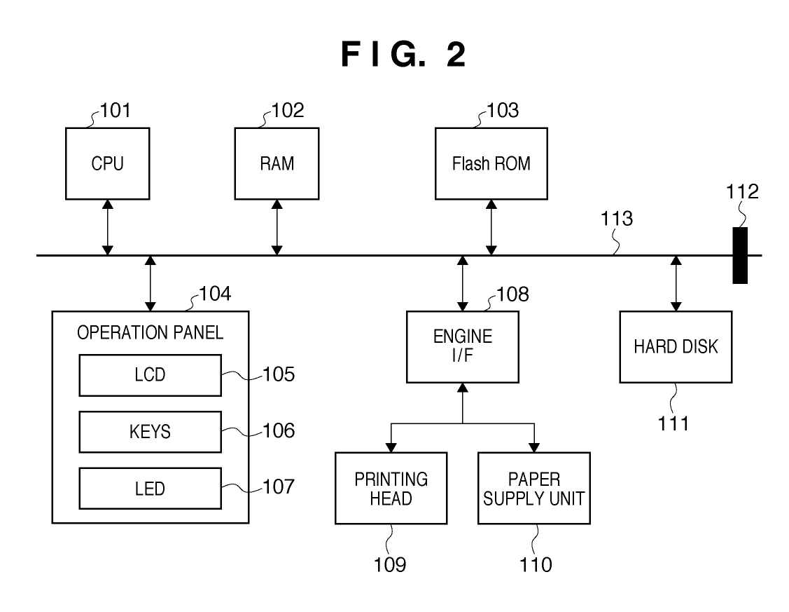

FIG. 2 is a block diagram illustrating a printing apparatus in the aforementioned printing system. Because the printing apparatuses 4 and 5 have the same configurations, the description hereinafter of printing apparatus 4, as an example, applies also to printing apparatus 5. The printing apparatus 4 includes a CPU 101, a RAM 102, a flash ROM 103, an operation panel 104, an engine interface 108, a hard disk 111, and a host interface 112. These are connected to each other via a system bus 113. The operation panel 104 includes an LCD 105, keys 106, and LEDs 107. The engine interface 108 connects a printing head 109 with a paper supply unit 110 and the system bus 113.

The CPU 101 executes programs pre-stored in the flash ROM 103. The CPU 101 also functions as a central processing unit that controls printing through operational instructions from the operation panel 104 or print jobs from the host computers 1 to 3. The RAM 102 temporarily stores various information when the CPU 101 executes programs, temporarily stores print jobs received via the host interface 112, and so on. The flash ROM 103 is a non-volatile storage device that stores programs for controlling the printing apparatuses 4 and 5, configuration information for menus to be displayed in the LCD 105, and so on. The operation panel 104 is a user interface for the user to carry out menu configuration changes, various operations, and so on, for confirming the state of the printing apparatuses 4 and 5, and the like.

The LCD 105 displays the state of the printing apparatus 4, guides for user operations such as setting paper, and so on. The keys 106 are configured so as to include up, down, left, and right keys for moving the menu, a cancel key for canceling, an OK key for changing settings, making selections in selection screens, and so on. The LEDs 107 are configured so as to include a data LED that is lit when print data has been received, an error message LED that is lit when an error has occurred, and so on. The engine interface 108 is connected to the printing head 109 and the paper supply unit 110, and communicates commands, print data, statuses, and so on between the printing head 109 and the paper supply unit 110 and system bus 113. The printing head 109 forms images by ejecting ink onto paper based on print data that has been sent via the engine interface 108 in order to carry out printing operations. The paper supply unit 110 supplies printing media (paper or the like) for printing. The paper supply unit 110 can supply, for example, paper in roll form, cut paper, or the like. The paper supply unit 110 carries out paper supply operations in accordance with commands sent via the engine interface 108. The hard disk 111 is a high-capacity non-volatile storage unit for storing multiple pieces of large-sized data such as print jobs. In the present embodiment, this hard disk is used as a temporary loading region when a print job is put on hold. The host interface 112 is connected to the host computers 1 to 3 via the network, and receives print jobs from the host computers 1 to 3.

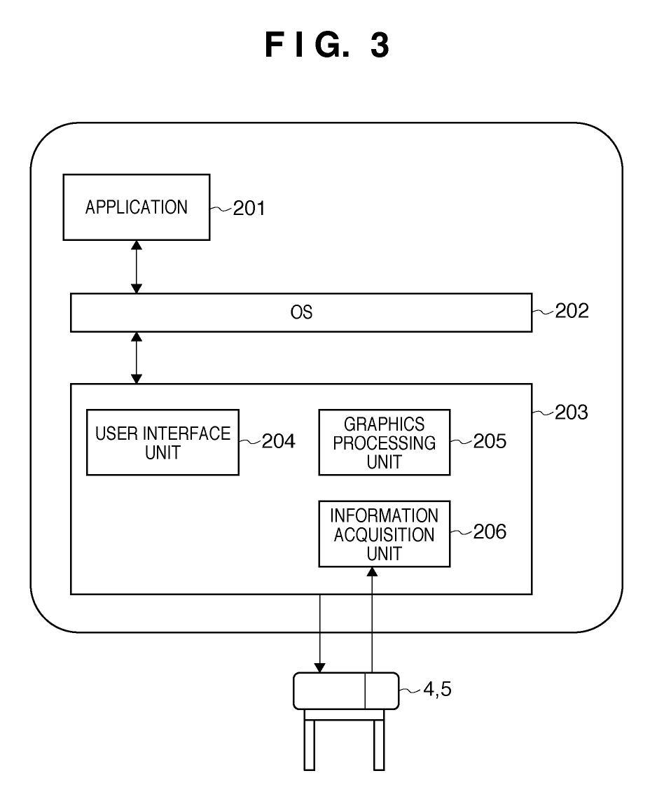

FIG. 3 is a block diagram illustrating a host computer in the aforementioned printing system. Because the host computers 1 to 3 all have the same configuration, the host computer 1 will be described as an example hereinafter. An operating system (OS) 202, a printer driver 203 for controlling the printing apparatuses 4 and 5, and an application 201 for creating various types of documents are installed in the host computer 1. With the host computer 1, various types of documents created using the application 201 can be printed as a result of the OS 202 and the printer driver 203 operating. The printer driver 203 includes a user interface unit 204, a graphics processing unit 205, and an information acquisition unit 206. The user interface unit 204 receives inputs from the user, communicates statuses to the user, and so on. The graphics processing unit 205 generates print data to send to the printing apparatuses 4 and 5. The information acquisition unit 206 acquires various states from the printing apparatuses 4 and 5. The host computer 1 is an information processing apparatus such as a PC, and is thus configured so as to include a CPU, storage units such as a ROM, a RAM, and the like, a display unit that displays user interfaces and the like, input units such as a keyboard, a mouse, or the like, and so on.

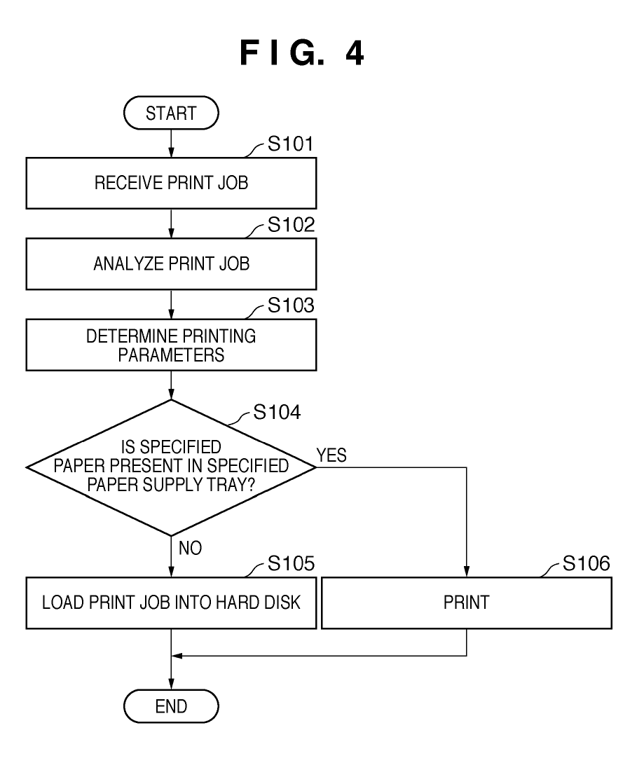

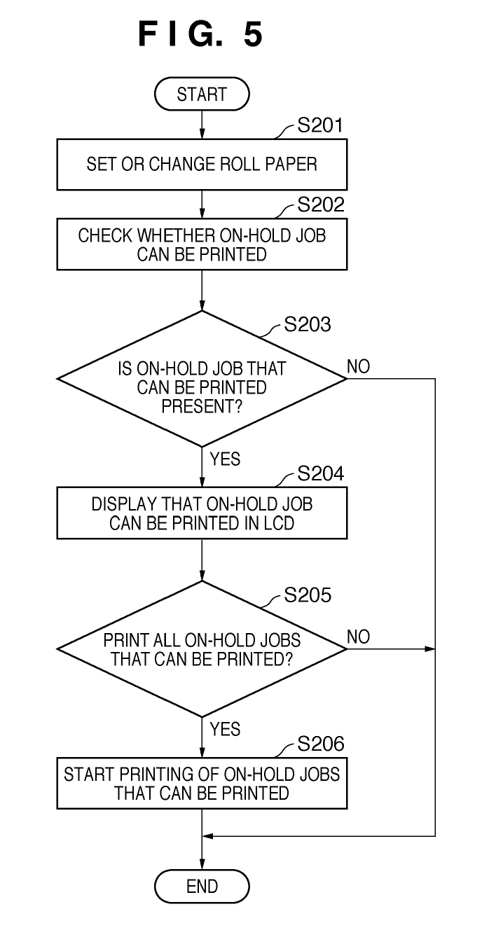

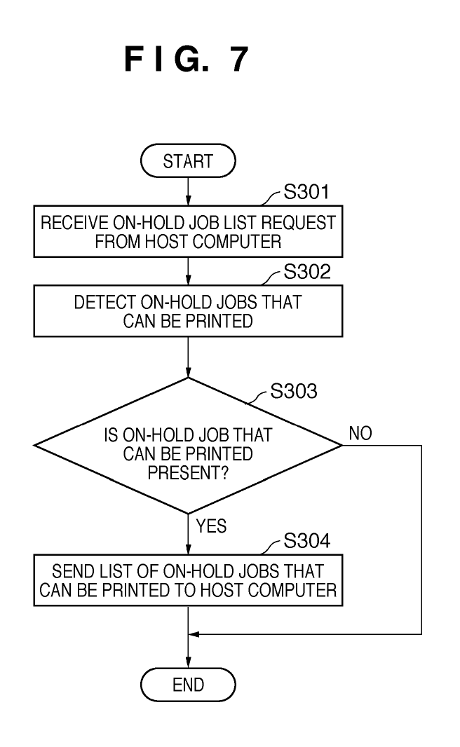

FIG. 4 is a flowchart illustrating the steps of a process for putting a print job on hold in this printing system. The processes illustrated in FIG. 4, as well as in FIGS. 5 and 7, which will be described later, are executed by, for example, the CPU 101 illustrated in FIG. 2. Upon receiving a print job from, for example, the host computer 1 (S101), the CPU 101 stores the received print job in a job buffer in the RAM 102. Then, the CPU 101 reads out the print job stored in the job buffer in sequence from the start of the print job and analyzes that print job (S102). The print job includes printing parameter information. The printing parameter information includes, for example, paper supply tray information (a roll paper tray, a cut paper tray, or the like) specifying where the paper is to be supplied from, paper type information (plain paper, coated paper, or the like) specifying what type of paper printing is to be carried out on, and the like. The printing parameter information is contained in, for example, the leading portion of the print job. When this printing parameter information has been confirmed (S103), the CPU 101 determines whether or not the specified type of paper is present in the specified paper supply tray (S104). Here, in the case where it has been determined that this paper is present, operations for printing the received print job are carried out (S106). However, in the case where it has been determined that this paper is not present, the received print job is loaded into the hard disk 111, and the printing apparatus enters a state in which it stands by for the reception of the next print job (S105). In this case, the paper supply tray information and paper type information included in the analyzed print job are also loaded into the hard disk 111.

In the case where, for example, a print job in which roll paper was specified for the paper supply tray and coated paper was specified for the paper type was received through the aforementioned operations but the roll paper that is set is plain paper or roll paper is not set, the print job cannot be executed. Normally, in this case, an error indicating that no paper is set (no paper) or that the paper type is wrong (paper type mismatch) is displayed in the LCD 105, and the printing apparatus stands by for the user to perform operations to eliminate the error. However, this causes the printing apparatuses 4 and 5 to enter a stopped state, making it impossible to execute subsequent jobs. In order to prevent this, the received print job data is loaded into the hard disk 111, but the printing apparatuses 4 and 5 do not enter the stopped state when “no paper”, “paper mismatch”, or the like have been detected. The loaded print job is saved in the hard disk 111 until the specified paper type is set. Such a state is called putting a print job “on hold”. In the case where a subsequent print job is also determined to correspond to “no paper” or “paper mismatch”, that print job is also loaded into the hard disk 111 and put on hold. Accordingly, multiple on-hold print jobs are present in the hard disk 111.

FIG. 5 is a flowchart illustrating the steps of a process for releasing an on-hold job in a printing apparatus in this printing system. When a user sets roll paper in the printing apparatus 4 or changes the paper (S201), the CPU 101 determines whether or not any of the print jobs that are currently on hold (also called “on-hold jobs”) are on-hold jobs that can be printed (S202). For example, it is determined, in the case where the user has changed the roll paper, whether or not an on-hold job for which the paper supply tray is specified as being roll paper matches with the paper type of the roll paper that has been set by the user. Likewise, it is determined, in the case where the user has set or changed cut paper, whether or not an on-hold job in which cut paper is specified matches with the paper type of the cut paper that has been set by the user.

In the case where the result of the determination performed in S203 indicates that, for example, an on-hold job that matches with the paper type of the roll paper that has been set is present in the printing apparatuses 4 and 5 and can be printed, a display is shown in the LCD 105 communicating to the user that the on-hold job can be printed (S204). However, in the case where it has been determined that an on-hold job that can be printed is not present, the process ends with nothing being performed.

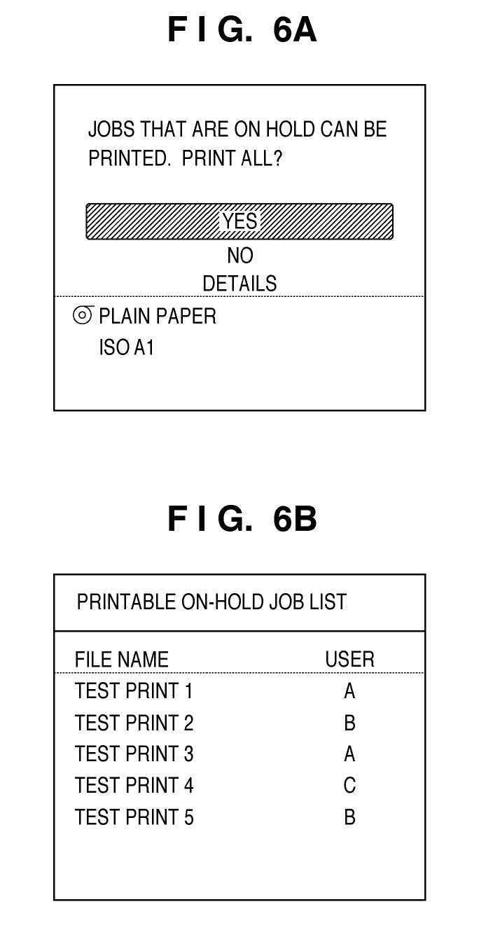

FIG. 6A is a diagram illustrating an example of the message displayed in S204. As illustrated in FIG. 6A, a display reading, for example, “Jobs that are on hold can be printed. Print all?” is displayed in the LCD 105 when the on-hold job can be printed. Furthermore, an icon of the paper tray, the paper type, and the paper size of the paper that is currently set is displayed in the lower portion of the LCD 105. FIG. 6A shows that plain paper of the ISO A1 size is set in the roll paper tray.

Next, in S205, the CPU 101 receives, from the user, a selection as to whether or not to print all of the on-hold jobs that can be printed. The printing apparatus 4 is connected to the multiple host computers 1 to 3 and is also used by multiple users. Therefore, it is not necessarily the case that an on-hold job was output by the user that set the paper. For example, assume that on-hold jobs from the user A, the user B, and the user C are all present in the printing apparatus 4. If all of the on-hold jobs that can be printed are automatically printed after, for example, the user B has set paper, the on-hold jobs of the users A and C will also be printed regardless of the intentions of those users. Furthermore, if the printing apparatus 4 prints the on-hold jobs of the users A and C regardless of the fact that, for example, the users A and C have output their on-hold jobs to the printing apparatus 5 and thus the on-hold jobs are no longer necessary in the printing apparatus 4, there are cases where consumable goods such as paper, ink, and so on will be wasted.

In order to prevent this from happening, in the present embodiment, the user is allowed to select whether or not to print all of the on-hold jobs that can be printed, rather than automatically printing all of the on-hold jobs that can be printed. When the user selects “yes” in the display shown in FIG. 6A and presses the OK key in the operation panel 104, the printing of all of the on-hold jobs commences, and this process ends (S206). However, in the case where the user selects “no” and presses the OK key, this process ends without anything being performed. Meanwhile, in the case where the user selects “details” in the display shown in FIG. 6A and presses the OK key, a list of the on-hold jobs that can be printed is displayed, as illustrated in FIG. 6B. Through this, the user can confirm the list of on-hold jobs that can be printed, and can then select “yes” or “no” in FIG. 6A having taken into account information of the users that output the print jobs that are on hold.

As described thus far, in the present embodiment, when the user has set the appropriate printing media in the printing apparatus 4, the user is prompted to select whether or not to print all of the on-hold jobs that can be printed using the display in the operation panel 104. As a result, it is possible to prevent unnecessary printing processes, such as printing on-hold jobs from other people. Meanwhile, in the case where “no” has been selected here, the list of on-hold jobs may be displayed in the operation panel 104, and the user may then be allowed to specify a job to be printed from that list and print the print job that has been specified. Furthermore, user authentication may be carried out at this time, and an instruction to print only the print jobs of that user may be carried out in the case where the authentication is successful.

Furthermore, in the present embodiment, the host computers 1 to 3 request the printing apparatus 4 to periodically provide a list of on-hold jobs that can be printed. In response to this request, the printing apparatus 4 generates the list of jobs that are currently on hold but can be printed, and sends that list to the host computer that made the request. The host computer can then make an instruction to print a desired on-hold job from the list of on-hold jobs that can be printed. This process will be described hereinafter.

FIG. 7 is a flowchart illustrating the steps of a process by which a printing apparatus sends on-hold job list information. In the present embodiment, the host computer 1, for example, periodically sends an on-hold job list request to the printing apparatus 4. Upon receiving the on-hold job list request from the host computer 1 (S301), the printing apparatus 4 detects on-hold jobs that can be printed among the print jobs that are currently on hold (on-hold jobs) (S302). For example, in the case where roll paper is set, this detection is realized by detecting on-hold jobs in which the paper tray is specified as roll paper and that match the paper type of the roll paper that is set. Likewise, in the case where cut paper is set, on-hold jobs in which cut paper is specified and that match the paper type of the cut paper that is set are detected.

In the case where it has been determined in S303 that on-hold jobs that can be printed are present, a list of the on-hold jobs that can be printed is generated, the on-hold job list is sent to the host computer that made the on-hold job list request (S304), and the process ends. However, in the case where it has been determined in S303 that an on-hold job that can be printed is not present, the process ends with nothing being performed.

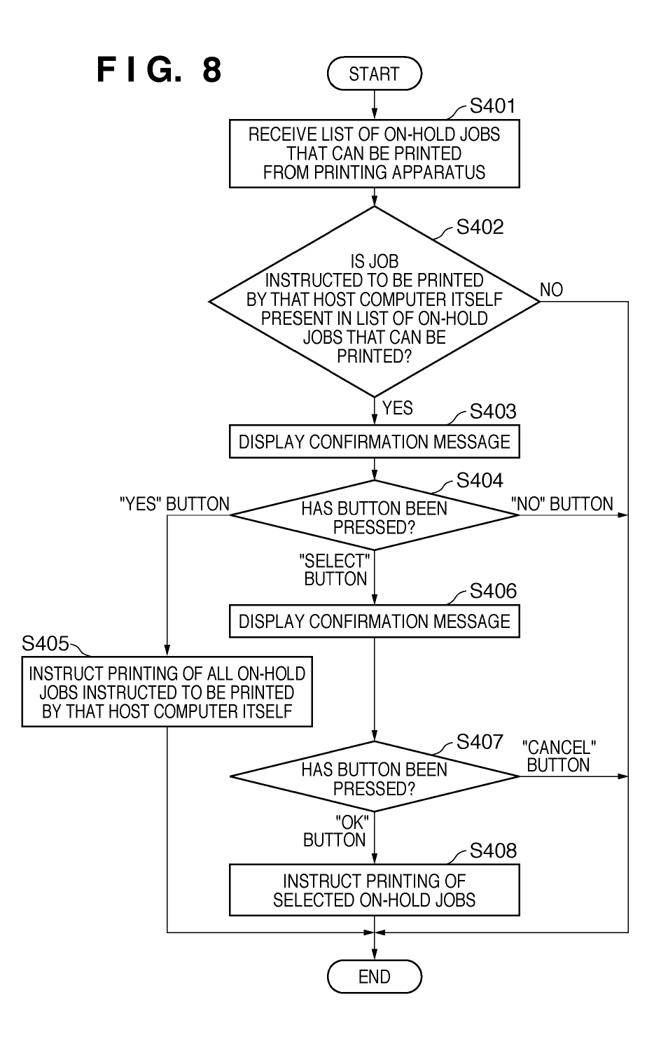

FIG. 8 is a flowchart illustrating the steps of a process by which a host computer receives on-hold job list information in this printing system. The processing illustrated in FIG. 8 is executed by, for example, a CPU of a host computer. The flowchart illustrated in FIG. 8 applies to all of the host computers 1 to 3, and therefore the host computer 1 will be described hereinafter as an example.

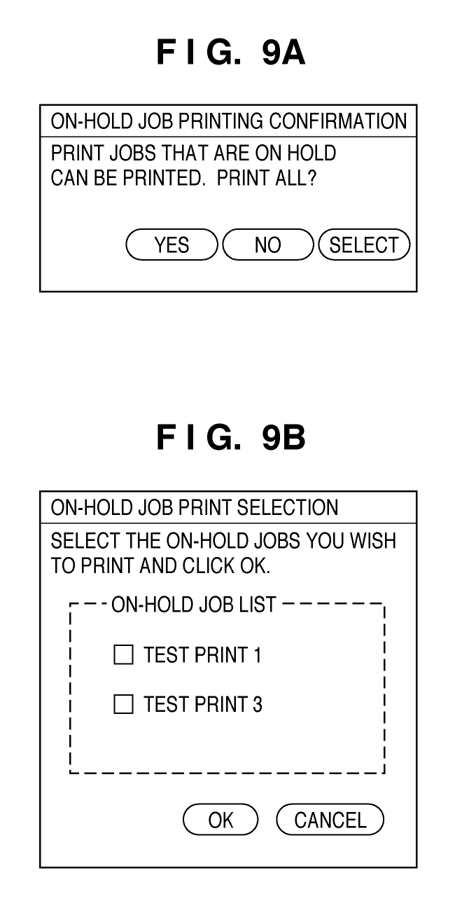

Upon receiving a list of on-hold jobs that can be printed from the printing apparatus 4 (S401), the host computer 1 determines whether or not a job that was instructed to be printed by the host computer 1 itself is present in the list of on-hold jobs that can be printed (S402). Here, in the case where it has been determined that a job that was instructed to be printed by the host computer 1 itself is present, a confirmation message is displayed in the display (S403). FIG. 9A is a diagram illustrating an example of the confirmation message displayed in S403. However, in the case where it has been determined that a job that was instructed to be printed by the host computer 1 itself is not present, the process ends with nothing being performed.

When the user presses the “yes” button, the “no” button, or the “select” button in the screen illustrated in FIG. 9A, the host computer 1 confirms the type of the button that was pressed, and determines the processing to be carried out thereafter (S404). Here, in the case where it has been determined that the button that was pressed is the “no” button, the process ends with nothing being performed. However, in the case where it has been determined that the button that was pressed is the “yes” button, an instruction is made to print all of the on-hold jobs that were instructed to be printed by the host computer 1 itself (S405). For example, in the case where the list of on-hold jobs that can be printed illustrated in FIG. 6B has been displayed in the host computer 1, which is used by the user A, only the on-hold jobs indicated as “test print 1” and “test print 3” are to be printed. Likewise, in the case of the user B, only the on-hold jobs “test print 2” and “test print 5” are to be printed, whereas in the case of the user C, only the on-hold job “test print 4” is to be printed.

Meanwhile, in the case where it has been determined that the button that was pressed is the “select” button, a job selection message is displayed in the display (S406). FIG. 9B is a diagram illustrating an example of a message displayed in the host computer used by the user A. In this case as well, the on-hold jobs that can be selected are limited to the jobs that were instructed to be printed by the user A. For example, as illustrated in FIG. 9B, in the case of the user A, only the on-hold jobs indicated as “test print 1” and “test print 3” are displayed as selectable on-hold jobs.

In S407, it is determined whether the user has selected an on-hold job to print in the job selection message and pressed the OK button, or if the user has pressed the cancel button. Here, in the case where it has been determined that the “cancel” button has been pressed, the process ends with nothing being performed. However, in the case where it has been determined that the “OK” button has been pressed, the printing apparatus 4 is instructed to print the selected on-hold job (S408).

As described thus far, in the present embodiment, each user that has instructed printing is allowed to determine whether or not to print on-hold jobs, which makes it possible to prevent an on-hold job instructed to be printed by another user from being printed regardless of the intentions of that other user.

As described with reference to FIG. 5, a screen that allows a selection as to whether or not all of the on-hold jobs are to be printed is displayed when the user has changed the paper of the printing apparatus. In the case where it has been selected not to print all of the on-hold jobs in this screen (that is, in the case where the “no” button has been pressed in the state illustrated in FIG. 6A), a screen such as that illustrated in FIG. 9A may be displayed in the printing apparatus. In that case, as illustrated in FIG. 9B, the on-hold jobs to be printed can be selected. In such a case, it is determined whether or not on-hold jobs that can be printed are present in the printing apparatus (S303 in FIG. 7), a confirmation message such as that illustrated in FIG. 9A is displayed in the operation panel 104 of the printing apparatus (S402 of FIG. 8), and the processing is then carried out in accordance with the button that is pressed (S404 to S408).

### Other Embodiments

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-002373, filed Jan. 7, 2010, which is hereby incorporated by reference herein in its entirety.

What is claimed is:

1. A printing apparatus comprising:
a detection unit configured to detect, among print jobs that are on hold, a print job that has entered a printable state;
an output unit configured to output a list of print jobs detected by the detection unit; and
a processing unit configured to carry out a printing process on a print job specified from among the print jobs included in the list output by the output unit.

2. The printing apparatus according to claim 1, further comprising a receiving unit configured to receive a request for the list of print jobs, among print jobs that are on hold, that have entered a printable state,
wherein in the case where the printing apparatus can carry out printing using the type of printing medium specified in a print job sent from an information processing apparatus that sent the request received by the receiving unit, the detection unit detects that print job as being a print job that has entered a printable state.

3. The printing apparatus according to claim 1,
wherein the output unit outputs, to an information processing apparatus that sent a print job, among the print jobs that are on hold, that has entered the printable state, a list of those print jobs; and
the processing unit carries out a printing process on a print job specified by the information processing apparatus.

4. A print job control method comprising the steps of:
detecting, among print jobs that are on hold in a printing apparatus, a print job that has entered a printable state;
outputting a list of the detected print jobs; and
carrying out, in the printing apparatus, a printing process on a print job specified from among the print jobs included in the output list.

5. A computer-readable storage medium in which is stored a program that can be executed by a computer, the program causing the computer to:
detect, among print jobs that are on hold in a printing apparatus, a print job that has entered a printable state;
output a list of the detected print jobs; and
carry out, in the printing apparatus, a printing process on a print job specified from among the print jobs included in the output list.
